(19) United States
(12) Patent Application Publication
(10) Pub. No.: US 2026/0029645 A1
(43) Pub. Date: Jan. 29, 2026

(54) ELECTRONIC BRIDGE

(71) Applicant: Apple Inc., Cupertino, CA (US)

(72) Inventors: Nathanael D. Parkhill, Menlo Park, CA (US); Cameron A. Harder, San Francisco, CA (US); John Raff, Menlo Park, CA (US)

(21) Appl. No.: 18/785,897

(22) Filed: Jul. 26, 2024

(51) Int. Cl. G02B 27/01

(52) U.S. Cl. CPC G02B 27/0172; G02B 27/0176; G02B 2027/0178; G02B 2027/0187

(57) ABSTRACT

A wearable display device can include a display including a display frame including a first lateral side and a second lateral side. A first securement arm removably coupled to the first lateral side at a proximal end of the first securement arm. The first securement arm can include a first electronic component and a projector configured to direct light displayed at the display. A second securement arm removably coupled to the second lateral side at a proximal end of the second securement arm. The second securement arm can include a second electronic component. An electronic connector can be configured to extend between the proximal ends of the first and second securement arms and electrically couple the first electronic device to the second electronic device. The electronic conductor can also be configured to couple to the display frame and conform to a shape of the display frame.

### FIELD

The described embodiments relate generally to electronic devices. More particularly, the present embodiments relate to head mountable devices.

### BACKGROUND

Recent advances in portable computing have enabled head-mountable devices (HMD) that provide augmented and virtual reality (AR/VR) experience to users. These HMDs have many components, such as a display, viewing frame, lens, batteries, processors, projectors, and other components. Various components of HMDs can house the electronic components and secure the device to the user's head, for example, viewing frames and securement arms or bands. Electrical connections between these components can enable power and data transmission from one component to another. However, swapping out the viewing frames, securement arms, bands, or other components of an HMD can jeopardize the proper functioning of those connections and data transmissions due to degradation of the connections over time. In addition, electrical connections and components increases design and manufacturing complexity.

Therefore, a need exists in the art for a head mountable device having interchangeable components designed to minimize electrical connection degradation over time as components are swapped by users.

### SUMMARY

In accordance with various examples of the present disclosure, a wearable display device, or head mountable device, can include a display portion having a display frame. In some examples, the display frame can include a first lateral side and a second lateral side. In some examples, a first securement arm can be removably coupled to the first lateral side at a proximal end of the first securement arm. In at least one example, the first securement arm can include a first electronic component and a projector configured to direct light to the display portion. In some examples, a second securement arm can be removably coupled to the second lateral side at a proximal end of the second securement arm. The second securement arm can include a second electronic component.

In some examples, the head mountable device can include an electrical conductor extending between the proximal ends of the first and second securement arms, and electrically coupling the first electronic device to the second electronic device. In some examples, the electronic conductor can be configured to couple to the display frame and conform to a shape of the display frame.

In some examples, the display frame can include a lens holder defining an upper brow rim extending between the first and second lateral sides. In at least one example, the shape of the display frame includes a contour of the upper brow rim.

In at least one example, the wearable display device can further include an electrical bridge. In some examples, the electrical bridge can include the electrical conductor, a sheath surrounding the electrical conductor, and a coupler configured to removably secure the electrical bridge to the display frame. In some examples, the coupler can include a magnet. In other examples, the coupler can include a mechanical coupling feature configured to mechanically secure the electrical bridge to the display frame.

In some examples, a contour of the electrical bridge can be configured to change based on the shape of the display frame during normal use. In at least one example, a first shape of the first housing and a second shape of the second housing can be configured to be maintained independently from the shape of the display frame during normal use.

In some examples, the first electronic component of the wearable display device can include a battery. In at least one example, the second electronic component can include a processor.

In at least one example, a pair of securement arms for the head mountable display device can include a first securement arm and a second securement arm. In some examples, the first securement arm can include a first arm housing, a first proximal end defining a first display frame hinge connection, and a first electronic device. The second securement arm can include a second arm housing, a second proximal end defining a second display frame hinge connection, and a second electronic device.

In some examples of the present disclosure, the electrical bridge can connect the first securement arm and the second securement arm at or near the proximal ends. Additionally, the electrical bridge can include a conductive element electrically coupling the first electronic device to the second electronic device. In at least one example, the electrical bridge can also include a cover surrounding the conductive element, where the cover can be more flexible than the first arm housing and the second arm housing.

In another example, the pair of securement arms can further include a projector configured to direct light out through the first proximal end. Additionally, the first electronic device can include a battery. In some examples, the second electronic device can include a processor or a speaker.

In some examples, the cover of the electrical bridge can include an electrical insulator. In at least one example, the electrical bridge can be configured to be molded to conform to a shape of the head mountable display device and can be re-molded to conform to a different shape of a separate head mountable display device.

In at least one example of the present disclosure, a first arm can include a first electronic device. Additionally, the first arm can be configured to be removably secured to a lens frame. In some examples, a second arm can include a second electronic device. The second arm can also be configured to be removably secured to the lens frame. In some examples, the electrical bridge can mechanically connect the first arm and the second arm and electrically couple the first electrical component and the second electrical component. In at least one example, the electrical bridge can be configured to be removably coupled to the lens frame.

In some examples, the electrical bridge can include an electrical conductor and an electrically insulating sheath surrounding the electrical conductor. In at least one example, the electrical bridge can include a data transfer cable. In at least one example, the first electronic device can include an antenna. Additionally, the second electronic device can include a processor.

In at least one example, the first arm can include a proximal end configured to be removably secured to the lens frame, and a distal end opposite the proximal end. The second arm can include a second proximal end configured to be removably secured to the lens frame. In some examples, the second arm can also include a second distal end opposite the proximal end. In at least one example, the electrical bridge can be coupled to the first arm at or near the first proximal end, and can be connected to the second arm at or near the second proximal end. Additionally, the first distal end and the second distal end can be configured to be disposed behind respective ears of a user when donning the electronic device.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a top view of an example of a head mountable device;

FIG. 2 shows a front view of an example of a head mountable device;

FIG. 3A shows a front view of an example of a portion of a head mountable device;

FIG. 3B shows a front view of an example of a frame for a head mountable device;

FIG. 3C shows a front view of an example of a frame for a head mountable device;

FIG. 4 shows a cross-sectional view of an example of an electronic bridge and an example of a frame of a head mountable device;

FIG. 5 shows a front view of an example of a portion of a head mountable device separated from a frame; and

FIG. 6 shows a front view of an example of a portion of a head mountable device separated from a frame.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to an electronic device. More particularly, the present embodiments relate to a head mountable device. In at least one example, a head mountable device can include a display portion, having a display frame that includes a first lateral side and a second lateral side. In some examples, a first securement arm can be removably coupled to the first lateral side at a proximal end of the first securement arm. Similarly, a second securement arm can be removably coupled to the second lateral side at a proximal end of the second securement arm. In at least one example, the first securement arm can include a first electronic component and a projector, and the second securement arm can include a second electronic component. In some examples, an electrical bridge can be configured to couple to the display frame and connect at least the first and second electronic components.

Current head mountable devices may not have the ability to remove and swap viewing frames, securement arms, or other components. Users may want to swap out frames depending on the way they are using the device, for example, one frame for leisure activities, another frame for working, and another frame for exercising. Swapping out the viewing frame of a head mountable device can require complicated steps and can result in electrically or mechanically disconnecting select components from each other. Furthermore, electrical connections that are repeatedly separated and reconnected can be prone to degradation over time. The embodiments of head mountable devices in accordance with the present disclosure, such as the display frame and the electrical bridge of the head mountable devices, (including the components disposed within), are designed to improve user comfort as well as overall integrity and reliability of the head mountable device.

In a particular example, the display frame can include a lens holder defining an upper brow rim extending between the first and second lateral sides. In this example, the shape of the display frame can include the contour of the upper brow rim. Additionally, the display frame can be removably coupled to both the first and second securement arms of the head mountable device. In this way, different display frames can be attached to the head mountable device with different shapes or contours for desired use cases. This can increase user comfort in when using the head mountable device in various activities.

When swapping out frames of different shapes, in a particular example, the electrical bridge can be configured to conform to the contour of the upper brow rim of the display frame. In some examples, the electrical bridge can be more flexible than the first and second securement arms as well as the display frame. In this manner, the electrical bridge can be flexibly attached to physically conform to the display frame. This can allow the electrical bridge to electrically connect the electronic components housed in both the first and second securement arms through the display frame. This can further provide the head mountable device with a reliable connection between the components of the device that does not need to be disconnected when changing the display frame on the head mountable device.

In a particular example, the electrical bridge can be removably coupled to the display frame. In some examples, the display frame and the electrical bridge can include couplers that can increase the retention of the electrical bridge to the display frame. In some examples, the couplers can include a mechanical coupling feature. In this example, the display frame can include latches, clasps, or other systems capable of retaining the electrical bridge.

In another example, the couplers can include magnets. In this example, the electrical bridge can include magnets spaced out across its length. Additionally, magnets can be disposed within the display frame so as to increase the magnetic forces exerted to keep the electrical bridge retained. In this way, the electrical bridge can be retained within and conform to the display frame when used during a wide variety of activities.

In a particular example, the electrical bridge can include an electrical conductor. Furthermore, the electrical conductor can be surrounded by an electrically insulating sheath. Additionally, the electrical bridge can be configured to include a data transfer cable. This can enable the electronic components disposed within the head mountable device to connect to each other. The insulating sheath can further protect the electrical bridge and can contain the electrical charge within the circuit of the head mountable device. In some examples, the insulating sheath can be flexible so as to further enable the electrical bridge to conform to different contours and shapes of the display frame.

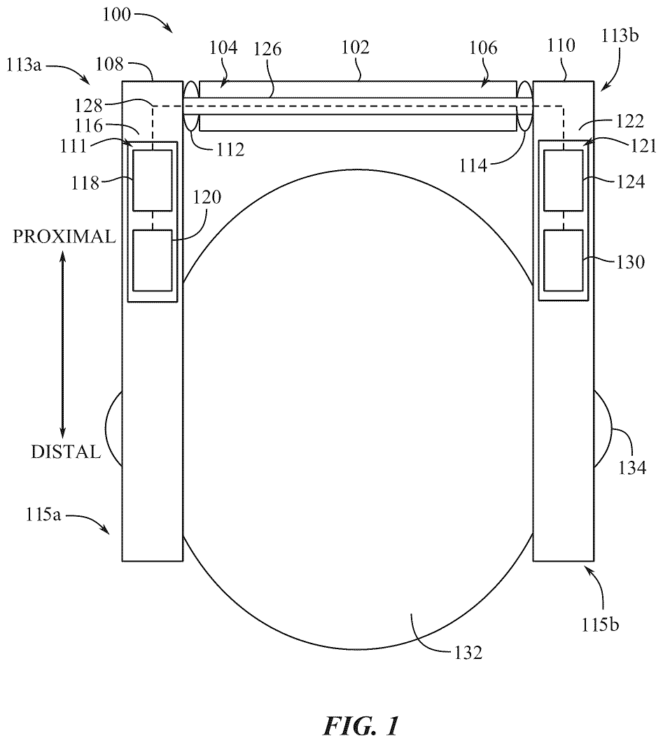

These and other embodiments are discussed below with reference to FIGS. 1-6. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top-down view of a head mountable device 100 in accordance with one or more examples of the present disclosure. In at least one example, the head mountable device 100 can include a portion configured to display images to a user. In some examples, the display portion of the head mountable device 100 can include a display frame 102. When donned by a user, the display frame 102 can be configured to be disposed in front of a user's head 132 such that the user can look into the display frame 102. In some examples, the display frame 102 can be a lens frame configured to include one or more lenses, a screen, or other components through which a user can look. In at least one example, the display frame 102 can include a first lateral side 104 and a second lateral side 106, where the first and second lateral sides 104 and 106 can be a left half and a right half of the display frame 102, as oriented on the head 132 of the user.

In at least one example, the head mountable device 100 can further include a first securement arm 108 and a second securement arm 110. The first and second securement arms 108 and 110 can be elongated members that can extend across a length of the user's head 132. In some examples, the first and second securement arms 108 and 110 can enable the head mountable device 100 to rest on, and be secured to, the user's head 132. In at least one example, different portions of the first and second securement arms 108 and 110 can be described in terms of being proximal and distal in respect to the display frame 102. For example, the first securement arm 108 can include a first proximal end 113a and a first distal end 115a. Likewise, the second securement arm 110 can include a second proximal end 113b and a second distal end 115b. As shown in FIG. 1, the first and second proximal ends 113a and 113b of the first and second securement arms 108 and 110 can be opposite their first and second distal ends 115a and 115b, respectively.

In at least one example, the first and second distal ends 115a and 115b can be configured to rest behind a user's ears 134 when donning the head mountable device 100. In such an example, the head mountable device 100 can sit firmly on the user's head 132. The securement arms 108, 110 can secure the head mountable device on a user's head 132 during use.

In some examples of the present disclosure, the first securement arm 108 can be removably coupled to the first lateral side 104 of the display frame 102 at the first proximal end 113a. Furthermore, the first proximal end can define a first display hinge 112. In at least one example, the first display hinge 112 can connect the first securement arm 108 to the display frame 102. In some examples, the first display hinge 112 can enable the first securement arm 108 to bend with respect to the display frame 102.

Similarly, the second securement arm 110 can be removably coupled to the second lateral side 106 of the display frame 102 at the second proximal end 113b. Furthermore, the second proximal end 113b can define a second display hinge 114. Like the first display hinge 112, the second display hinge 114 can connect the second securement arm 110 to the display frame 102. Additionally, the second display hinge 114 can enable the second securement arm 110 to bend relative to the display frame 102.

In at least one example, the first securement arm 108 can include a first housing 116. In some examples, a housing can be defined as an external component or portion defining cavity 111 or other internal volume disposed within a securement arm accommodating various components of the head mountable device 100. For example, a first electronic component 118 can be disposed within a cavity 111 of the first housing 116 of the first securement arm 108. In at least one example of the present disclosure, the first electronic component 118 can be a battery, a processor, a speaker, or other type of electronic device. In other examples, the first electronic component 118 can also include an antenna.

Additionally, a projector 120 can be disposed within the first housing 116 of the first securement arm 108. The projector 120 can be another electronic device that can direct light to be displayed at the display portion carried by the display frame 102 of the head mountable device 100. In at least one example, the projector 120 can be configured to direct light out of the first proximal end 113a. The light displayed by the projector onto the display frame 102 can be in the form of images and other types of information. In this manner, the head mountable device 100 can respond and interact with a user.

In some examples, the second securement arm 110 can include a second housing 122. Similar to the first housing 116, the second housing 122 defining a cavity 121 for accommodating various components of the head mountable device 100. In at least one example, a second electronic component 124 can be disposed within the second housing 122 of the second securement arm 110. Like the first electronic component 118 disposed within the first housing 116, the second electronic component 124 can be a battery, a processor, a speaker, or other type of electronic component, system, or device. Additionally, the second housing 122 can be configured to include a third electronic component 130. In accordance with one or more examples of the present disclosure, the third electronic component 130 can be any of the devices listed above. In another example, the third electronic component 130 can also be another projector.

In some examples of the present disclosure, the electronic components 118, 124, 130, and the projector 120 can be rearranged and disposed in different positions within the first and second securement arms 108 and 110. For example, the projector 120 can be disposed within the second housing 122 of the second securement arm 110. Furthermore, batteries, speakers, processors, and other components can be disposed within the first securement arm 108, the second securement arm 110, or both the first and second securement arms 108 and 110. In one example, the first electronic component 118 can be a battery and the second electronic component 124 can be a processor.

In some examples of the present disclosure, the display frame 102 can be detachable from the first and second securement arms 108 and 110. In this way, a user of the head mountable device 100 can replace or change the display frame 102 with another frame of a different design or type as needed or desired without replacing the entire head mountable device 100.

In at least one example, an electrical bridge 126 can extend between the first and second proximal ends 113a and 113b of the first securement arm 108 and the second securement arm 110, where the electrical bridge 126 can be separate from the display frame 102. The electrical bridge 126 can be an electrical conductor including a conductive element. The electrical bridge 126 can electrically connect the first and second securement arms 108 and 110 together. In some examples, the electrical bridge 126 can electrically couple the electrical components housed within the first securement arm 108 to the electrical components housed within the second securement arm 110. In this manner, the electrical bridge 126 can mechanically connect the first and second securement arms 108 and 110 and electrically couple at least the first and second electronic components 118 and 124.

Additionally, the electronic components in the first housing 116 and the second housing 122 can be electrically coupled by means of an internal circuit 128. In one example, the circuit 128 can be one of multiple circuits or include multiple circuits electrically coupled multiple electronic components. For example, the projector 120 and the first electronic component 118 can be electrically coupled together by the internal circuit 128. Likewise, the internal circuit 128 can electrically couple the second electronic component 124 and the third electronic component 130. In some examples, the internal circuit 128 can extend through the electrical bridge 126. In this manner, the electrical bridge 126 can therefore be configured to electrically couple all the electronic components housed within the head mountable device 100, including components within the securement arms 108, 110.

In this manner, the electrical bridge 126 can connect between the first and second securement arms 108 and 110 even if the display frame 102 is detached from the head mountable device 100. In this way, the first and second securement arms 108 and 110 can be mechanically connected when the display frame 102 is detached. Similarly, the electronic components housed within the first and second securement arms 108 and 110 can remain electrically coupled even when the display frame 102 is detached. In such an example, the display frame 102 can be swapped out without disconnecting any electrical and/or data connections between the first and second securement arms 108, 110. Thus, the electrical connection between components within the head mountable device 100 can be uninterrupted, which can lead to increased longevity, efficiency, and reliability of the electrical connections between components.

In some examples of the present disclosure, the electrical bridge 126 can be more flexible than the display frame 102. Furthermore, the electrical bridge 126 can be configured to be more flexible than the first and second securement arms 108 and 110. In accordance with the present disclosure, flexibility can be defined as the ability of a component or structure to bend, twist, or otherwise move from its initial shape or position while still retaining functionality. For example, the electrical bridge 126 can bend into different shapes while mechanically connecting the first and second securement arms 108, 110, and electrically connecting the electronic components housed in both securement arms.

Any of the features, components, and/or parts, of the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

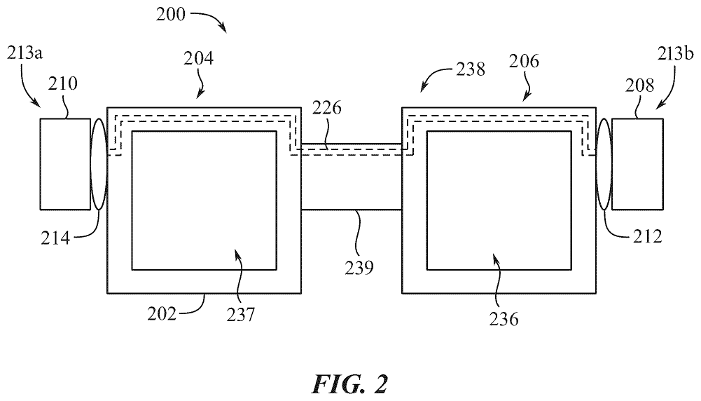

FIG. 2 illustrates a front view of the head mountable device 200 in accordance with one or more examples of the present disclosure. In at least one example, the electrical bridge 226 can connect the first securement arm 208 and the second securement arm 210 at or near their respective proximal ends 213a and 213b. In some examples, the electrical bridge 226 can connect to or through the first and second display hinges 212 and 214.

In some examples, the display frame 202 can define a first lens aperture 236. A lens aperture can be defined as a space where a lens, screen, or other transparent viewing device can be inserted into and secured by the display frame 202. In at least one example, the display frame 202 can further include a second lens aperture 237 so as to account for a user's eyes. Additionally, the display frame 202 can include a nose bridge 239. The nose bridge 239 can be an extension of the display frame 202 between the first lens aperture 236 and the second lens aperture 237.

In some examples of the present disclosure, the display frame 202 can define an upper brow rim 238. In some examples of the present disclosure, the upper brow rim 238 can be the top ridge of the display frame 202. For example, the upper brow rim 238 can include the portion of the display frame 202 above the first lens aperture 236, the nose bridge 239, and the second lens aperture 237. In this manner, the upper brow rim 238 can extend across the first and second lateral sides 204 and 206. Furthermore, the shape of the display frame 202 can follow the contour of the upper brow rim 238.

In at least one example, the electrical bridge 226 can be configured to couple to the display frame 202. For example, as shown in FIG. 2, the electrical bridge 226 can conform to the shape of the upper brow rim 238. For example, the electrical bridge 226 can run through the display frame 202 above the first lens aperture 236, through the nose bridge 239, and above the second lens aperture 237. In this manner, the electrical bridge 226 can connect between the first and second securement arms 208 and 210 while conforming to the specific shape of the display frame 202. In this way, the first and second securement arms 208 and 210 can be mechanically and electrically connected in a comfortable and aesthetically pleasing manner. In at least one example, the electrical bridge 226 can be disposed within the upper brow rim 238 of the display frame 202. In this manner, the electrical bridge can be shielded from outside forces, debris, and other influences. For example, the ability of the electrical bridge 226 to conform to the shape of the upper brow rim 238 can help prevent the electrical bridge 226 from catching and/or snagging on various objects.

Any of the features, components, and/or parts, of the arrangements and configurations thereof shown in FIG. 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2.

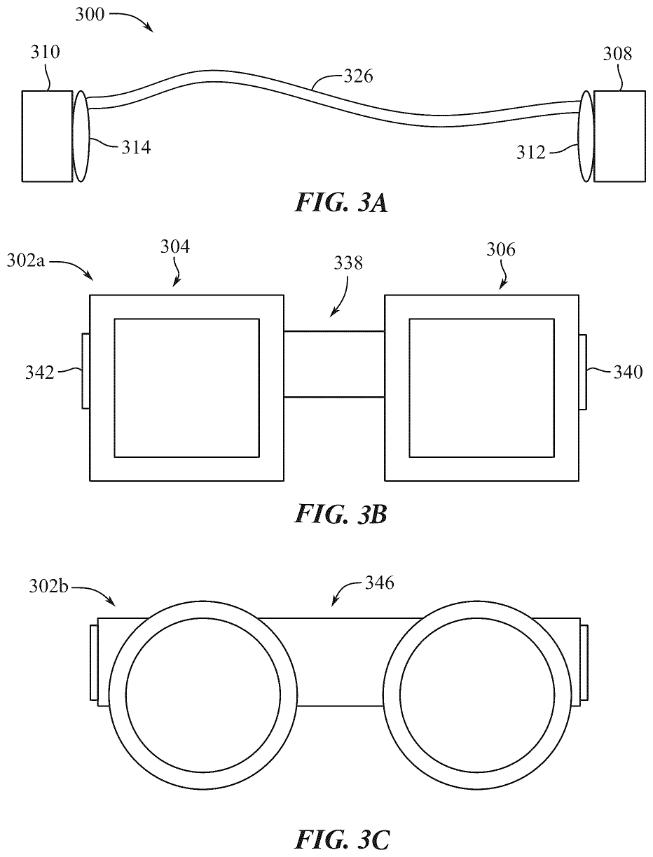

FIG. 3A illustrates a front view of a portion of a head mountable device, including first and second securement arms 308, 310 and an electrical bridge 326, and FIGS. 3B and 3C illustrate examples of different shaped display frames 302a, 302b in accordance with one or more examples of the present disclosure. In at least one example, at least the first display frame 302a shown in FIG. 3B can be attached to the head mountable device 300 by a first hinge interconnection 340 and a second hinge interconnection 342. According to the present disclosure, the first and second hinge interconnections 340 and 342 can be latches, fasteners, magnets, or other types of coupling devices. In at least one example, the first hinge interconnection 340 can be disposed on the edge of the first lateral side 304 of the display frame 302a. Similarly, the second hinge interconnection 342 can be disposed on the edge of the second lateral side 306 of the display frame 302a. In at least one example, the display frame 302a can also attach to the head mountable device 300 in a similar manner.

In some examples, the first and second hinge interconnections 340 and 342 can enable the display frame 302a to connect to the first and second display hinges 312 and 314, respectively. For example, the first hinge interconnection 340 can be a latch, fastener, or other type of coupler that can attach to the first display hinge 312. In at least one example, the first display frame 302a shown in FIG. 3B can be configured to attach and detach from the first and second securement arms 308 and 310. In this way, the frame 302a of a head mountable device can be exchanged and/or replaced without disconnecting any electrical or mechanical connections between the first and second securement arms 308, 310. In this manner, the shape of the housing of the first and second securement arms 308 and 310 can be maintained independently from the shape of the display frame 302a during normal use. When changing display frames, electronic components and connections need not be altered to accommodate a new display frame.

In accordance with one or more examples of the present disclosure, it can be advantageous to a user of a head mountable device to attach a second display frame 302b. In at least one example, many of the features of the second display frame 302b can be different from the first display frame 302a. For example, the second display frame 302b can have a different shape than the first display frame 302a. For example, the lens apertures and/or the brow rim 346 of the second display frame 302b can be different in shape than the first display frame 302a. Other features can also differ between the first display frame 302a and the second display frame 302b. For example, it can be advantageous for the user to swap out lenses of differing size, shape, tint, prescription, and so forth, based on the intended use of a head mountable device. The differences can enable a more comfortable experience for users with different head sizes and other variable facial features, or for the same users wanting to use the device for different activities. For example, the second display frame 302b can have a longer nose bridge to accommodate a user with a larger nose or the first display frame 302a can be a tighter fit for a user wanting to use the device for outdoor recreation and/or exercise.

In at least one example, the contour of the electrical bridge 326 can change based on the shape of the display frame 302a-b during normal use of a head mountable device. For example, as shown in FIG. 2, the electrical bridge 320 can conform to the upper brow rim 338 of the display frame 302. In this manner, the electrical bridge 326 create a reliable mechanical and electrical connection between the first and second securement arms 308 and 310 in a comfortable and aesthetically pleasing manner.

In some examples, the flexible nature of the electrical bridge 326 can enable it to be molded to conform to a shape of a display frame and remolded to conform to different styles and shapes of various display frames. As shown in FIGS. 3B and 3C, a first display frame 302a as well as a second display frame 302b can be attached to the head mountable device. In both of these configurations, the electrical bridge 326 can conform to the shape of the display frame attached of the head mountable device. This can enable the electrical bridge 326 to conform not only to the upper brow rim 328 of the first display frame 302a, but also to an upper brow rim 346 of the second display frame 302b. In some examples, the electrical bridge 326 can be configured to conform to the upper brow rims of additional styles and shapes of other display frames. This can be beneficial in that many different shapes and styles of display frames can be attached to the head mountable device 300 without having to change the mechanical features or electronic components disposed in the first and second securement arms 308 and 310. This can further enhance user comfort as well as the reliability of electrical connections when swapping display frames.

Any of the features, components, and/or parts, of the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

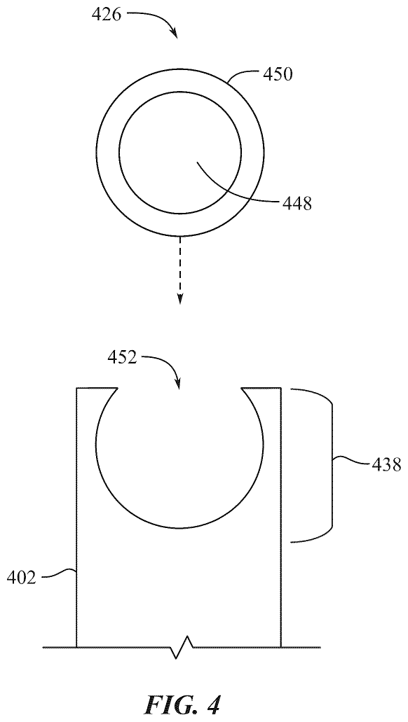

FIG. 4 illustrates a cross-sectional view of an example of an electrical bridge 426 and an upper brow rim 438 of a display frame 402 in accordance with one or more examples of the present disclosure. In at least one example, the electrical bridge 426 can include an electrical conductor 448. In one example, the electrical conductor 448 includes multiple conductors, for example a bundle of conductors. In one example, the electrical conductor 448 is one of multiple electrical conductors of the electrical bridge 426. In some examples, the electrical conductor 448 can be the core of the electrical bridge 426. Furthermore, the electrical conductor 448 can be a conductive material that runs the length of the electrical bridge 426. For example, the electrical conductor can be made of copper, steel, or other conductive materials. Additionally, the electrical conductor 448 can be flexible, so as to be able to conform to shapes of different display frames.

In some examples of the present disclosure, the electrical bridge 426 can also include a flexible sheath 450. The flexible sheath 450 can be a cover surrounding the electrical conductor 448. For example, the flexible sheath 450 can extend around the circumference of the electrical conductor 448. Furthermore, the flexible sheath can extend across the surface area of the electrical conductor 448. In at least one example, the flexible sheath 450 can be made of a flexible material, such that the flexible sheath 450 can be more flexible than the securement arms 108, 110 or the head mountable device 100 shown in FIG. 1.

In at least one example, the flexible sheath 450 can be constructed out of an electrically insulating material to contain electrical impulses traveling through the electrical conductor 448. In this manner, the flexible sheath 450 can help protect the electrical conductor 448 of the electrical bridge 426 from making contact with water, sweat, and other undesirable substances. Additionally, the flexible sheath 450 can be constructed out of a material that can be resistant to abrasions, cuts, tearing, or other types of damage. This can further enable the flexible sheath to protect the electrical conductor 448 when bending to conform to different display frame shapes.

In at least one example, the electrical bridge 426 can be configured as a data transfer cable. In such an example, the electronic components housed in one securement arm can communicate with electronic components in the other securement arm. For example, a processor in one of the securement arms can help control a projector located in the other securement arm. In this manner, the electronic components disposed within both of the securement arms of a head mountable display device can be configured to work as a single electrical system or device.

In at least one example, the electrical bridge 426 can be removably coupled to the display frame 402. In some examples, the upper brow rim 438 of the display frame 402 can define a bridge channel 452. The bridge channel 452 can be a cavity in the top of the display frame 402 that runs through the upper brow rim 438. In at least one example, the bridge channel 452 can be configured to receive the electrical bridge 426.

When the electrical bridge 426 is inserted into the bridge channel of the display frame 402, the flexible sheath 450 of the electrical bridge 426 can lie flush with the top of the upper brow rim 438. In this way, the electrical bridge 426 can be disposed within the display frame 402. The electrical bridge 426 can thus avoid snagging on unwanted objects. The electrical bridge 426 inserted into the bridge channel 452 can result in the electrical bridge 426 remaining in a fixed position and shape in accordance with the shape of the brow rim 438 during use of the head mountable device.

Any of the features, components, and/or parts, of the arrangements and configurations thereof shown in FIG. 4 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4.

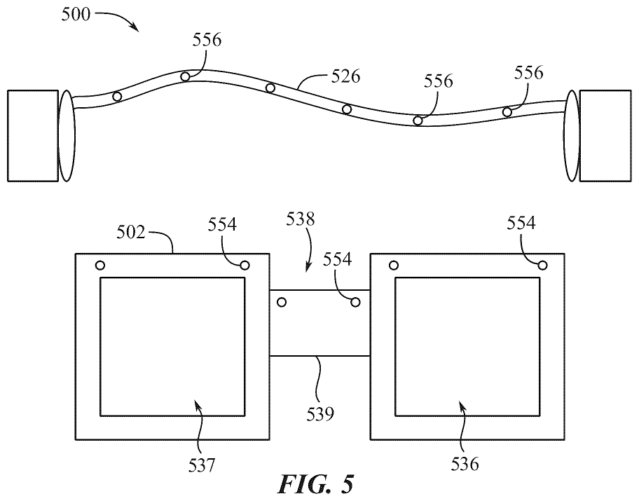

FIG. 5 illustrates a front view of an example of a head mountable device 500 in accordance with one or more examples of the present disclosure. In at least one example, the head mountable device 500 can include one or more frame couplers 554 configured to removably secure an electrical bridge 526 to a display frame 502. In at least one example, the set of frame couplers 554 can be disposed within an upper brow rim 538 of the display frame 502. In some examples, the frame couplers 554 can be configured to hold the electrical bridge 526 to or within the upper brow rim 538 of the display frame 502. Furthermore, the frame couplers 554 can also be configured to assist the electrical bridge 526 in conforming to the shape of the upper brow rim 538.

In at least one example, the frame couplers 554 can be disposed across the upper brow rim 538 of the display frame 502 in various locations. As shown in FIG. 5, the frame couplers 554 can be disposed in locations beneficial in the retention of the electrical bridge 526. For example, frame couplers 554 can be disposed above the first and second lens apertures 536 and 537 as well as across the nose bridge 539. In some examples, the position of the frame couplers 554 can be in locations where the electrical bridge 526 can be configured to bend the most, such as at the corners of the lens apertures or at the junction between the lens apertures 536, 537, and the nose bridge 539. In this way, the frame couplers 554 can cause the electrical bridge 526 to conform to the shape of the display frame 502.

In one example of the present disclosure, the frame couplers 554 can be a mechanical coupling feature configured to mechanically secure the electrical bridge 526 to the display frame 502. The mechanical coupling features can be a type of latch, button, clasp, or other mechanism able to retain the electrical bridge 526 within the upper brow rim 538. For example, the frame couplers 554 can be a kind of clasp into which the electrical bridge 526 can snap. Alternatively, the frame couplers 554 can be a kind of latch that can be closed around the electrical bridge 526.

In another example, the set of frame couplers 554 can include a magnets configured to magnetically secure the electrical bridge 526 to the display frame 502. In at least one example, the frame couplers 554 can be magnets disposed within the upper brow rim 538 of the display frame 502. In this manner, the frame couplers 554 can exert a magnetic force on the electrical bridge 526 such that the electrical bridge 526 can be retained within the upper brow rim 538 of the display frame 502. In this way, the electrical bridge 526 can be easily inserted and retained within the display frame 502.

In at least one example, the electrical bridge 526 can be configured to include a set of bridge couplers 556 to help secure the electrical bridge 526 to the display frame 502. In some examples, the bridge couplers 556 can be disposed across a length of the electrical bridge 526. In one example, the bridge couplers 556 can be part of a mechanical system. For example, the bridge couplers 556 can be buttons, snaps, or other mechanisms that can enable the electrical bridge 526 to attach to the display frame 502. In some examples, the bridge couplers 556 can be configured to connect to the frame couplers 554 in a mechanical manner.

In other examples, the bridge couplers 556 can include magnets. In this example, magnets can be disposed across the length of the electrical bridge 526. In this example, the magnets of the bridge couplers 556 can be configured to line up with the magnets of the frame couplers 554 when the electrical bridge 526 is inserted into the upper brow rim 538 of the display frame 502. This can enable the display frame 502 to exert a retention force on the electrical bridge 526 capable of retaining it within or on the upper brow rim 538. In some examples, the number of frame couplers 554 can equal the number of bridge couplers 556. In other examples, the number of frame couplers 554 can be different from the number of bridge couplers 556.

In yet another example of the present disclosure, the set of frame couplers 554 and the bridge couplers 556 can include a mix of both mechanical and magnetic features configured to secure the electrical bridge 526 to the display frame 502. This can be advantageous in that both the benefits from a mechanical retention system and a magnetic retention system can be used to retain the electrical bridge 526 within the display frame 502.

In any of the examples discusses above with reference to FIG. 5, the couplers 556, 554 of the electrical bridge 526 and display frame 502, respectively, can be configured to cause the shape or contour of the electrical bridge 526 to conform to the shape of the upper brow rim 538 of the display frame 520.

Any of the features, components, and/or parts, of the arrangements and configurations thereof shown in FIG. 5 can be included, cither alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

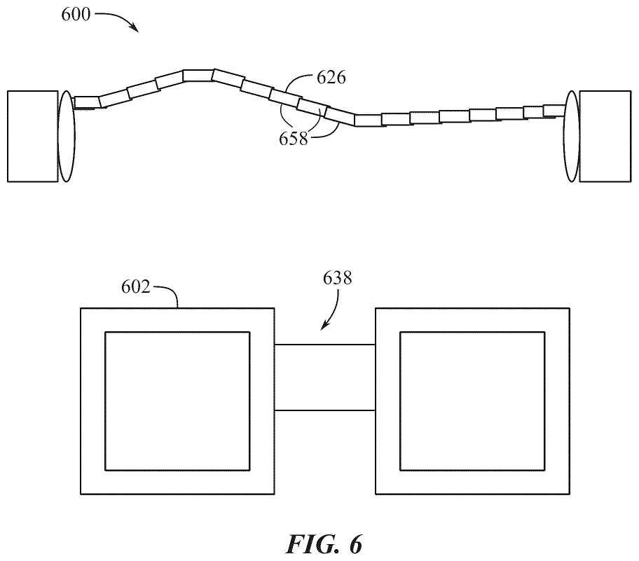

FIG. 6 illustrates a front view of an example of head mountable device 600, showing another example of an electrical bridge 626. In at least one example, the electrical bridge 626 can include a series of bridge segments 658. In some examples, the bridge segments 658 can vary in length, width, and height. According to the present disclosure, the bridge segments 658 can be disposed in place of the flexible sheath 450, as shown in FIG. 4. In other examples, the bridge segments 658 can be disposed outside of the flexible sheath 450 shown in FIG. 4, thus creating another layer around the electrical bridge 626. Additionally, the bridge segments 658 can be made out of an insulating material, a metallic material, or a mix of both insulating and metallic materials.

In at least one example, the electrical bridge 626 that includes bridge segments 658 can be configured to conform to the shape of the upper brow rim 638 of the display frame 602. For example, the addition of bridge segments 658 can help protect the electrical bridge, while also enabling the electrical bridge 626 to bend at the junctions between bridge segments 658. In this manner, the electrical bridge 626 can remain flexible as a whole while the bridge segments 658 are stiff or unbending individually.

Any of the features, components, and/or parts, of the arrangements and configurations thereof shown in FIG. 6 can be included, either alone or in any combination, in any of the other examples of devices, features, components, and parts shown in the other figures. Likewise, any of the features, components, and/or parts, including the arrangements and configurations thereof shown in the other figures can be included, cither alone or in any combination, in the example of the devices, features, components, and parts shown in FIG. 6.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

1. A wearable display device, comprising:
a display including a display frame comprising a first lateral side and a second lateral side;
a first securement arm removably coupled to the first lateral side at a proximal end of the first securement arm, the first securement arm including:
a first electronic component; and
a projector configured to direct light to the display;
a second securement arm removably coupled to the second lateral side at a proximal end of the second securement arm, the second securement arm including a second electronic component; and
an electrical conductor extending between the proximal end of the first securement arm and the proximal end of the second securement arm and electrically coupling the first electronic component to the second electronic component;
wherein the electronic conductor is configured to be removably coupled to the display frame and conform to a shape of the display frame.

2. The wearable display device of claim 1, wherein:
the display frame includes a lens holder defining an upper brow rim extending between the first lateral side and the second lateral side; and
the shape of the display frame includes a contour of the upper brow rim.

3. The wearable display device of claim 1, further comprising an electrical bridge including:
the electrical conductor;
a sheath surrounding the electrical conductor; and
a coupler configured to removably secure the electrical bridge to the display frame.

4. The wearable display device of claim 3, wherein the coupler comprises a magnet.

5. The wearable display device of claim 3, wherein the coupler comprises a mechanical coupler configured to mechanically secure the electrical bridge to the display frame.

6. The wearable display device of claim 1, wherein the electrical conductor is more flexible than the display frame.

7. The wearable display device of claim 6, wherein:
a contour of the electrical bridge is configured to change based on the shape of the display frame; and
a first shape of the first housing and a second shape of the second housing are configured to be maintained independently from the shape of the display frame.

8. The wearable display device of claim 1, wherein:
the first electronic component comprises a battery; and
the second electronic component comprises a processor.

9. A pair of securement arms for a head-mountable display device, the pair of securement arms comprising:
a first securement arm comprising:
a first arm housing;
a first proximal end defining a first display frame hinge connection; and
a first electronic device;
a second securement arm comprising:
a second arm housing;
a second proximal end defining a second display frame hinge connection; and
a second electronic device; and
an electrical bridge connecting the first securement arm and the second securement arm at or near the first proximal end and the second proximal end, the electrical bridge comprising:
a conductive element electrically coupling the first electronic device to the second electronic device; and
a cover surrounding the conductive element, the cover being more flexible than the first arm housing and the second arm housing.

10. The pair of securement arms of claim 9, wherein the first securement arm further comprises a projector configured to direct light through the first proximal end.

11. The pair of securement arms of claim 9, wherein the first electronic device comprises a battery.

12. The pair of securement arms of claim 11, wherein the second electronic device comprises at least one of a processor or a speaker.

13. The pair of securement arms of claim 9, wherein the cover comprises an electrical insulator.

14. The pair of securement arms of claim 9, wherein:
the electrical bridge is configured to be molded to conform to a shape of the head-mountable display device; and
the electrical bridge is further configured to be re-molded to conform to a different shape of a separate head-mountable display device.

15. An electronic device, comprising:
a first arm including a first electronic component, the first arm configured to be removably secured to a lens frame;
a second arm including a second electronic component, the second arm configured to be removably secured to the lens frame; and
an electrical bridge mechanically connecting the first and second arms and electrically coupling the first electronic component and the second electronic component;
wherein the electrical bridge is configured to be removably coupled to the lens frame.

16. The electronic device of claim 15, wherein the electrical bridge comprises:
an electrical conductor; and
an electrically insulating sheath surrounding the electrical conductor.

17. The electronic device of claim 15, wherein the electrical bridge comprises a data transfer cable.

18. The electronic device of claim 17, wherein:
the first electronic component comprises an antenna; and
the second electronic component comprises a processor.

19. The electronic device of claim 15 wherein:
the first arm includes:
a first proximal end configured to be removably secured to the lens frame; and
a first distal end opposite the first proximal end;
the second arm includes:
a second proximal end configured to be removably secured to the lens frame; and
a second distal end opposite the second proximal end; and
the electrical bridge is coupled to the first arm at or near the first proximal end and to the second arm at or near the second proximal end.

20. The electronic device of claim 19, wherein the first distal end and the second distal end are each configured to be disposed behind an ear of a user when the electronic device is donned.
